(19) United States
(12) Patent Application Publication
(10) Pub. No.: US 2011/0000592 A1
(43) Pub. Date: Jan. 6, 2011

(54) Hammer and pry bar resilient pulling pad

(76) Inventor: Donald Landis Shenk, Lancaster, PA (US)

Correspondence Address: Donald L. Shenk, 412 E. Grant St., Lancaster, PA, 17602, US

(21) Appl. No.: 12/460,839

(22) Filed: Jul. 24, 2009

Related U.S. Application Data
(60) Provisional application No. 61/137,288, filed on Jul. 29, 2008.

(51) Int. Cl. B25C 11/00

(52) U.S. Cl. 150/161

(57) ABSTRACT

An improved claw hammer and pry bar having a resilient pulling pad installed on the fulcrum areas of said hammer and pry bar. There are various ways to install said pulling pads. Some embodiments have straps made of the same resilient material as the pad. Some are glued on at the factory. Some have peel off backing to be stuck on said hammer or pry bar in the field. Some have a Velcro attaching system.

### CROSS-REFERENCE TO RELATED APPLICATIONS

This application claims the benefit of provisional patent application Ser. No. 61/137,288, filed 2008 Jul. 27 by the present inventor.

### FEDERALLY SPONSORED RESEARCH

Not Applicable

### SEQUENCE LISTING OR PROGRAM

Not Applicable

### BACKGROUND

1. Field

This application generally relates to carpenter's claw hammer and pry bar, specifically to the fulcrum areas of the hammer and pry bar.

2. Prior Art

Using a claw hammer or pry bar on finished material or wood causes damage to the finished material at the fulcrum areas. The oldest reference to a claw hammer is a print by Albrecht Durer made in 1914. The name of the print is “Melancholia I” and appears at the website www.wikipedia.org. The claw hammer is in the middle left edge of the print. Claw hammers and pry bars have been causing damage to finished material while being used to pull nails or being used in a prying motion for 495 years. Historically carpenters have used a piece of wood or other material while using a hammer or pry bar to cushion the surface to be protected. It is frustrating and time consuming to find a suitable piece of wood to protect the work surface while prying with a hammer or pry bar. The advantage of a resilient pulling pad mounted to the fulcrum area of the hammer or pry bar is to provide for greater ease, speed, and efficiency.

### SUMMARY

A hammer or pry bar with a resilient pulling pad mounted on the fulcrum areas makes the tool more efficient and easier to use, thus saving time.

### DRAWINGS

### Figures

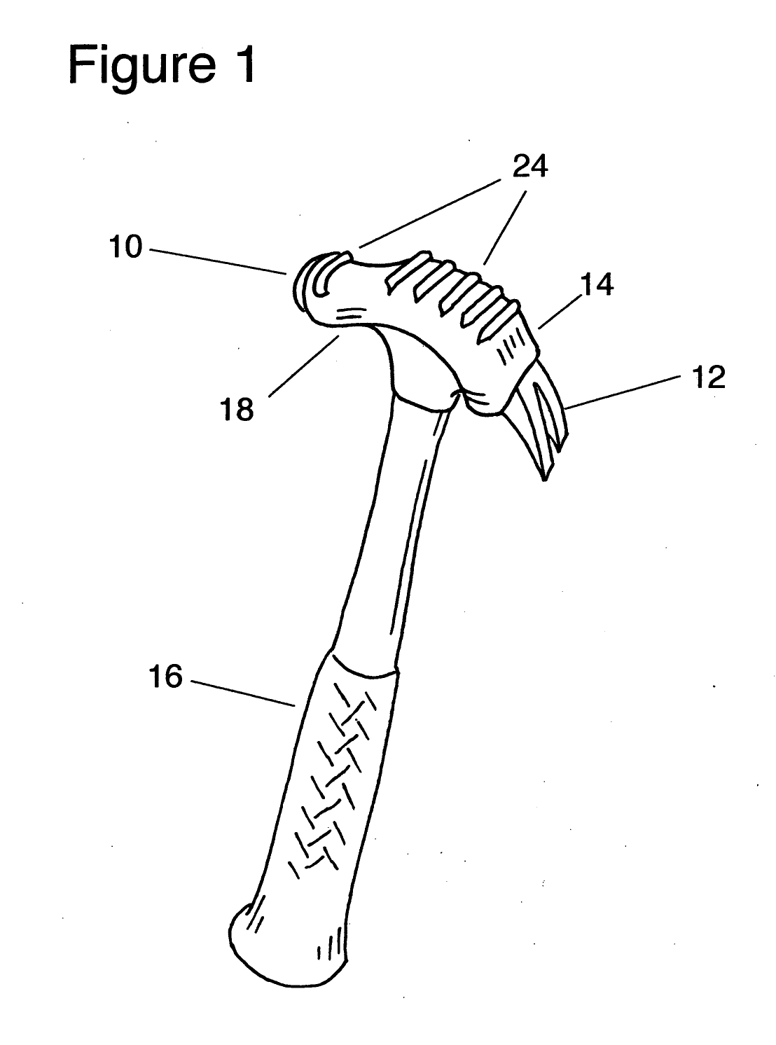

FIG. 1 is a perspective of a resilient pulling pad that is injection molded with ribs on the fulcrum area.

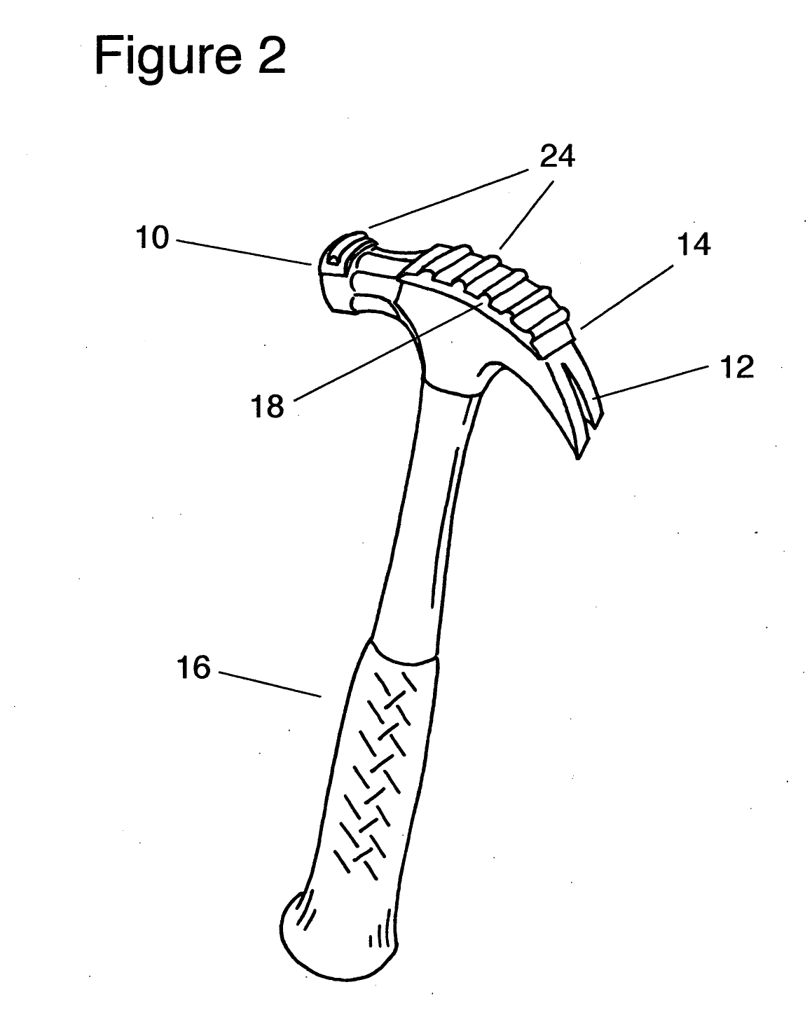

FIG. 2 is a perspective of a resilient pulling pad that is cut from flat material.

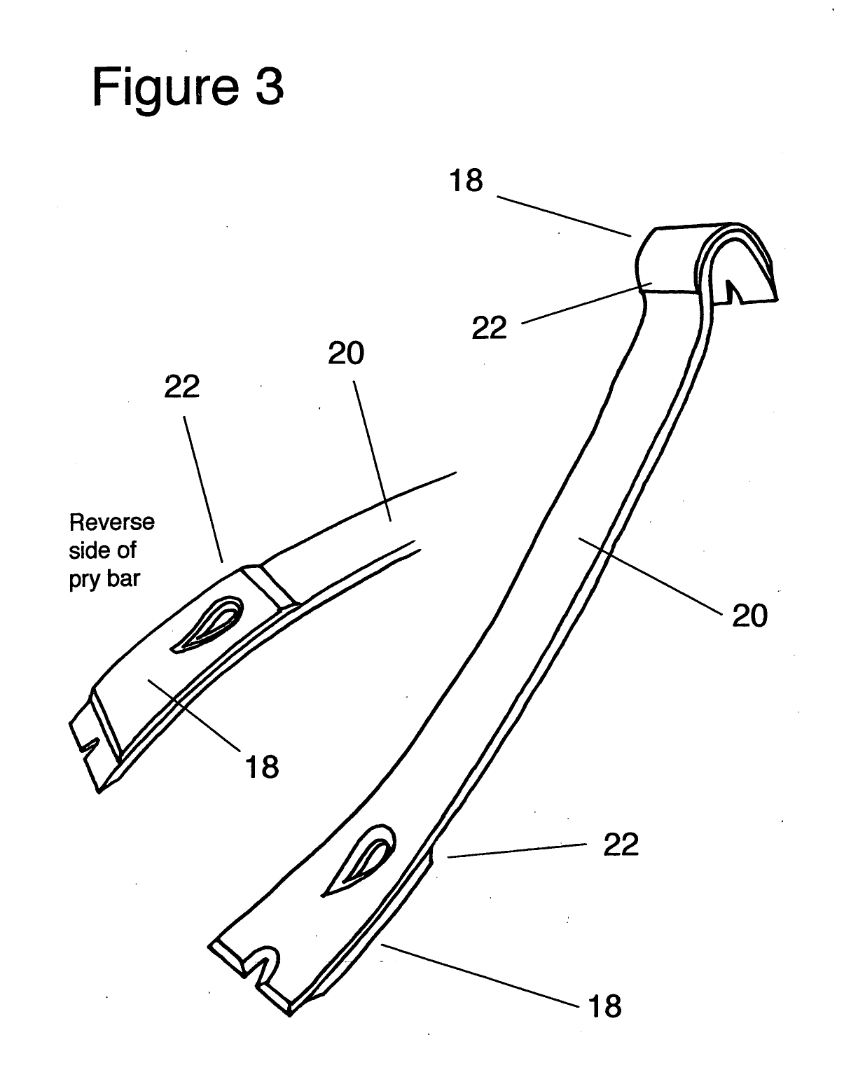

FIG. 3 is a perspective of a resilient pulling pad that is cut from flat material.

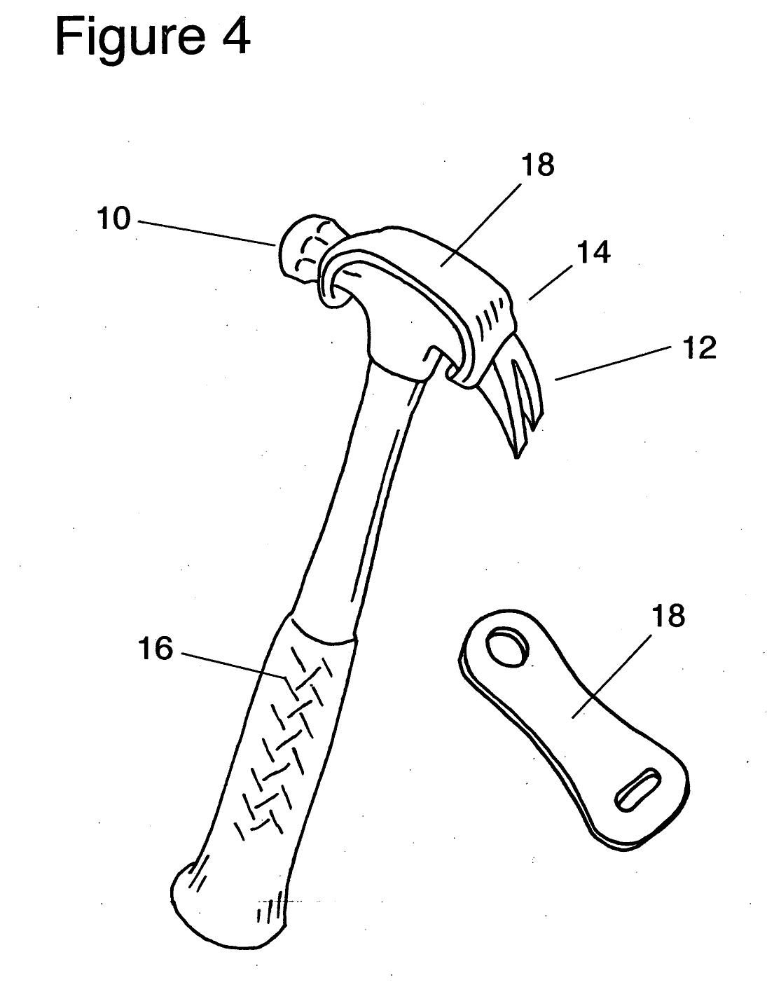

FIG. 4 is a perspective of a resilient pulling pad that is cut from flat material.

### DRAWINGS

### REFERENCE NUMERALS

10 hammer head face
12 hammer head claw
14 hammer head fulcrum area
16 hammer handle
18 resilient pulling pad
20 pry bar
22 pry bar fulcrum area
24 cushioning ribs

### DETAILED DESCRIPTION

### FIG. 1

### First Embodiment

FIG. 1 is a perspective view of a resilient pulling pad (18) that fits tight around the hammer head. It is a resilient sheath that fits snuggly over the hammer head following its contours. The face, claws, and bottom of the hammer head are exposed. There are a series of ribs (24) on the fulcrum of the hammer head (14) which provide added cushioning. Near the face of the hammer head there is an extra large rib which is also used for cushioning. A mold is created in the shape of a hammer head. Rubber, neoprene, polyurethane, or a suitable material is then injected into the molding.

### OPERATION

### FIG. 1

To install the resilient pulling pad slip the claw of the hammer (12) through the loop. The cylinder shaped end then slips over the face of the hammer (10). While the resilient pulling pad may be removed during demolition it is designed to remain on the hammer head. When the need arises to use the hammer in a prying motion on finished material the resilient pulling pad is ready to provide its benefit, cushioning the piece. Simply put the claw around a nail and pull in a normal manner. If two pieces of material need to be separated using the claw with attached resilient pulling pad, damage is eliminated.

### FIG. 2

### Second Embodiment

FIG. 2 shows a perspective view of another version of a resilient pulling pad. It is a soft product such as rubber, neoprene, polyurethane, or a suitable material. It is shaped in such a way as to cover the fulcrum area of the hammer head (14) including the top of the head above the face (10) of the hammer head. The resilient pulling pad can be sold separately and attached to the hammer or manufactured with the pulling pad glued to the hammer.

### OPERATION

### FIG. 2

When using a hammer with a resilient pulling pad in normal use pulling nails or prying, the pad (18, 24) protects the finished surface. Currently two hands are needed to protect a surface when removing nails or prying. One hand is on the hammer or pry bar and the other hand on the scrap piece protecting the surface. A resilient pulling pad allows for one hand operation offering added safety when on a stepladder.

### FIG. 3

### Third Embodiment

FIG. 3 is a perspective view of a resilient pulling pad (18) that is placed on the fulcrum areas (22) of a pry bar. It is a soft product such as rubber, neoprene, polyurethane, or a suitable material. It can be sold separately as an attachment to the pry bar or manufactured with the pulling pad glued to the pry bar.

### OPERATION

### FIG. 3

The resilient pulling pad protects finished surfaces while using the pry bar in a normal prying motion.

### FIG. 4

### Fourth Embodiment

FIG. 4 shows a perspective view of one version of a resilient pulling pad. It is a soft product made from rubber, neoprene, polyurethane, or a suitable material and shaped in such a way as to cover the fulcrum area of a hammer. It is made of a flat, resilient material. There is a hole in one end of the pulling pad that slips over the head (10) of the hammer. The opposite end has a slot that fits over the claw (12).

### OPERATION

### FIG. 4

Using the hammer in a prying motion with a resilient pulling pad in place protects the finished surface.

### CONCLUSION, RAMIFICATIONS, AND SCOPE

Accordingly, the reader will see that a resilient pulling pad of various embodiments can be used to protect surfaces that are damaged by a hammer or pry bar being used in a prying manner. The claw hammer is 495 years old and the said problem is that old. Rather than look around for a suitable piece of wood to cushion the hammer or pry bar while prying, a resilient pulling pad already installed saves time and frustration and can be used with one hand. This is a safety benefit when on a ladder because without a resilient pulling pad installed two hands are needed to protect a surface while prying. Each of the described embodiments has an appropriate application for the home handyman or the seasoned professional.

In FIG. 1 the injection molded resilient pulling pad provides an embodiment that is sleek and streamlined. It does not interfere with normal use of the hammer and it can be removed if the hammer is to be used in demolition.

FIG. 2 is a glue-on embodiment that would be installed by the hammer manufacturer. Another possibility is to sell the resilient pulling pad with glue to install it or a peel off backing that is self-sticking. This would be economical if the hammer is used in a rough manner.

FIG. 3 shows that a resilient pulling pad can be beneficial when used on the fulcrum area of a pry bar. The pad could be sold separately with glue to install it or it could have a peel off backing that is self-sticking. A pry bar manufacturer could fasten the pad to the pry bar at the factory.

FIG. 4 is a simple embodiment. It is easy to remove for rough demolition work but it is designed to rest on the hammer head when in normal use.

Although the description above contains many specificities these should not be construed as limiting the scope of the embodiments, but merely providing illustrations of some of the presently preferred embodiments. For example the ribs that provide additional cushioning could be installed on any of these embodiments. In addition different thicknesses could also be used depending on how much stretch is required in any given embodiment. Another variation would be to attach the resilient pulling pad with Velcro.

I claim:

1. A resilient pad:
a. That is placed on the fulcrum area of a hammer of pry bar, whereby said hammer or pry bar used in a prying motion on soft material such as wood, said pad prevents damage.
